(19) United States
(12) Patent Application Publication
(10) Pub. No.: US 2021/0216949 A1
(43) Pub. Date: Jul. 15, 2021

(54) METHOD AND DEVICE FOR AGREEING TO A COLLABORATION BETWEEN A FIRST SYSTEM AND A SECOND SYSTEM

(71) Applicant: Robert Bosch GmbH, Stuttgart (DE)

(72) Inventors: Arne Nordmann, Stuttgart (DE); Nik Scharmann, Bietigheim-Bissingen (DE); Peter Munk, Renningen (DE); Rakshith Amarnath, Hemmingen (DE); Simon Burton, Gerlingen (DE)

(21) Appl. No.: 17/056,247

(22) PCT Filed: May 22, 2019
(86) PCT No.: PCT/EP2019/063225

§ 371 Date: Nov. 17, 2020

(30) Foreign Application Priority Data
Jun. 22, 2018 (DE) 10 2018 210 224.4

(51) Int. Cl. G06Q 10/08; G06F 16/903; G06Q 20/36

(52) U.S. Cl. CPC G06Q 10/087; G06Q 20/36; G06F 16/903

(57) ABSTRACT

A method for agreeing to a collaboration between a first system and a second system. The method includes: assumptions of the first system with respect to the second system, and guarantees of the first system to the second system, are transmitted by the first system, assumptions of the second system with respect to the first system, and guarantees of the second system to the first system, are transmitted by the second system, if reciprocal assumptions and guarantees correspond to one another, a digital safety contract is concluded between the first system and the second system, and the safety contract is documented in a transaction database.

### FIELD

The present invention relates to a method for agreeing to a collaboration between a first system and a second system. The present invention moreover relates to a corresponding device, to a corresponding computer program, as well as to a corresponding memory medium.

### BACKGROUND INFORMATION

A decentralized transaction system or transaction database (distributed ledger) denotes any protocol in processor networks which brings about a consensus with respect to the sequence of certain transactions related, for example, to the updating of data. A frequent occurrence of such a system utilizes a blockchain.

A computer system which is connected to a blockchain is described in U.S. Pat. No. 9,794,074 B2, for example. The computer system receives match data for a match between a first data transaction which is associated with a first identifier, and a second data transaction which is associated with a second identifier. A first blockchain transaction is generated based on the data stored in the blockchain. At least one further blockchain transaction is generated, which splits the match into two different transactions: one between the first identifier and an intermediary, and the second between the intermediary.

These are recorded in the blockchain via the further blockchain transactions.

### SUMMARY

The present invention provides a method for agreeing to a collaboration between a first system and a second system, a corresponding device, a corresponding computer program, and a corresponding memory medium.

The method according to an example embodiment of the present invention is based on the finding that a growing number of safety-critical systems must collaborate during operation. These systems are at times developed by different manufacturers. As a result, they must cooperate with other systems, whose characteristics and properties are unknown at the point in time of their design. Examples of such systems are heterogeneous vehicles that communicate with one another, e.g., for calming or regulating traffic or for emergency services, highly automated trucks that form a convoy and automatically follow a leading truck having a human driver, conditionally automated trucks that form a convoy and automatically follow a leading highly automated truck, snow plows that automatically follow a laterally offset plow steered by a person on an airfield or a ski slope, cars that cooperate with a pilot system on a parking lot, agricultural robots that, similarly to a swarm, fertilize or harvest a field, or manufacturing robots that move on a driving surface and collaborate with other robots or even people to complete a shared task.

Due to the potential hazards, high requirements must be placed on the operational safety of these “systems of systems.” To cope with such dynamic configurations, taking the safety requirements into consideration, so-called safety contracts were provided. At the point of time a system is designed, a number of (formally described) assumptions and guarantees are defined for each system according to this approach. The guarantees of each system under the given assumptions may also be analyzed within the scope of the design using conventional safety analysis techniques. With regard to the run time, potentially cooperating systems exchange their assumptions and guarantees among one another. Each system then decides whether the guarantees of the other system meet its assumptions. If they match, a safety contract is concluded, which means that one's own guarantees are also met as long as the assumptions of each system are met. The assumptions and guarantees may also include parameters to enable more flexibility.

For example, two highly automated trucks shall be considered, which are to form a convoy. It shall be assumed in the process that the vehicles stem from different manufacturers, but that the safety contract format and the exchange protocol were arranged at the time of the design. The assumption of a truck could be that it is notified within a predefined time period X when the truck it is following decelerates. A guarantee, however, could be that the truck notifies trucks, which in turn follow it, within a predefined time period Y when the truck itself decelerates. The safety contracts may obviously only be concluded, and the convoy may thus only be formed, when Y<X, which both trucks have to check.

The provided approach furthermore takes into account the circumstance that, in general, there is a risk of a system failure. When a system fails, it may violate its guarantees, and when it collaborates with other systems at the point in time of the failure, it breaches its safety contract. Even though the safety contract has a technical origin, such situations may cause legal problems or necessitate a clarification of potential insurance claims, in particular since no person was involved in the concluding of the safety contract, and when different manufacturers are involved.

A main feature of an approach according to the present invention is that each system which has successfully concluded a safety contract with another system creates a data set, which includes these pieces of information, and transmits these to the transaction database.

When the other system fails and violates the safety contract by breaching the made guarantees, it cannot deny the concluding of the contract. In this way, legal certainty is achieved for the manufacturer. Manufacturers do not have to trust a single unit which stores the safety contracts, but they must consent to the proposed protocol and implement it.

The measures described herein allow advantageous refinements of and improvements on the basic idea of the present invention. It may be provided, for example, that the involved systems, after starting the collaboration, each repeatedly transmit a surroundings model to the transaction database, and that the latter adds the surroundings models to the blockchain. In the event of an error, these data cannot be disclaimed and may help to reconstruct the situation. If one of the participating systems fails, it is thus made easier for its manufacturer to verify that a safety contract not only existed, but also that another system violated it.

According to a further aspect of the present invention, it may be provided that the involved systems, after starting the collaboration, each repeatedly transmit a hash of the surroundings model to the transaction database, and that the latter only adds these hashes to the blockchain. The hash of the surroundings model is considerably smaller than the entire model and may thus be transmitted much more quickly to the transaction database. In the event of an accident, the manufacturer is able to verify that the surroundings recorded in the system database were not changed.

According to a further aspect, it may be provided that the systems establish a reciprocal transaction channel, via which they exchange pieces of information and signed messages, after the block including the safety contract has been received. This concept reduces the scope of the communication with the transaction database, by which typically transaction fees (in a cryptocurrency) are reduced. In addition, it may be automatically identified in the event of an error which system actually violated the safety contract, and a fine (in a cryptocurrency) may automatically be charged against a security deposit which both systems had to provide during the creation of the digital contract. The aforementioned specific embodiment also improves the legal certainty in the event of an accident since the most recently arranged pieces of information and their time stamps are known and stored in the transaction database.

According to a further aspect of the present invention, it may be provided that the blockchain of the transaction database is distributed among numerous terminals, and the systems involved in the safety contract manage a digital wallet, from which they remunerate the terminals for adding blocks. Using such a wallet, payments to the miners become possible, in which the participating systems could pay them an amount which is inversely proportional to the time which is required to verify the pieces of information relevant for the legal certainty and add them to the blockchain. Furthermore, a genuine economy of things (EoT) is made possible when participating systems in this way pay for the received work, or are paid when they themselves deliver a service to other systems, for example in the case of a preceding vehicle, which helps the following vehicle to assess the possibility of a passing maneuver beyond a curve situated ahead.

### BRIEF DESCRIPTION OF THE DRAWINGS

Exemplary embodiments of the present invention are shown in the figures and are described in greater detail below.

FIG. 1 shows a method according to which two systems arrange a legally secured collaboration with the aid of a blockchain, in accordance with an example embodiment of the present invention.

FIG. 2 shows a variant of the method in which the transaction database is equipped with computing functions and in this way is able to draw up the safety contract, in accordance with an example embodiment of the present invention.

FIG. 3 shows a variant of the method in which the systems establish a smart channel for exchanging pieces of information, in accordance with an example embodiment of the present invention. In the process, a system transmits pieces of information, which are considered to be erroneous by the other system, in accordance with an example embodiment of the present invention. Thanks to the computing function of the digital contract in the transaction database, it is possible to check which system is in the right and what the last overruling information was.

FIG. 4 schematically shows a control unit according to an example embodiment of the present invention.

### DETAILED DESCRIPTION OF EXAMPLE EMBODIMENT

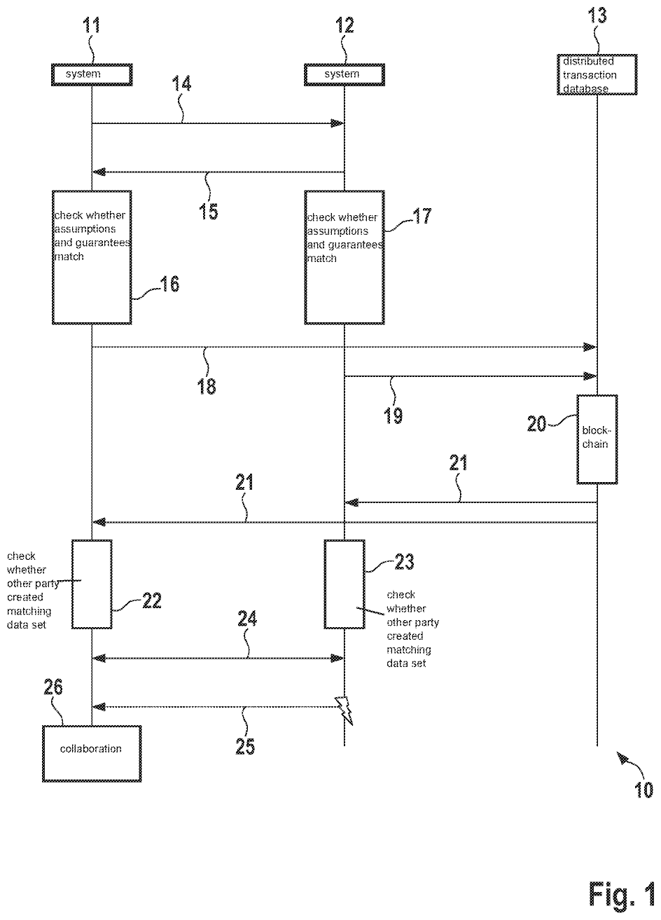

FIG. 1 shows the time axes of two systems 11, 12 from different manufacturers of a distributed transaction database 13. Systems 11, 12 communicate via an Internet connection with distributed transaction database 13, the communication between systems 11, 12 taking place directly from car to car (C2C) or also via an Internet connection. Initially, both systems 11, 12 exchange their assumptions and guarantees 14, 15, and each system checks 16, 17 whether they match, i.e., whether a safety contract may be signed. When this is the case, each system 11, 12 transmits a data set 18, 19 to transaction database 13. The particular data set 18, 19 may include the fundamental information that a safety contract was concluded, as well as the properties or the collectivity of the arranged assumptions and guarantees. Since both systems 11, 12 create a data set 18, 19, each data set 18, 19 may contain the identifier (ID) of the “opposite party” 12 or 11.

This ID should be unambiguous in the distributed transaction database 13 and is comparable to the so-called wallet ID of a cryptocurrency.

Two possible procedures lend themselves for the time period which is required until data set 18, 19 is added to distributed transaction database 13: either systems 11, 12 start the collaboration and dispense with exhaustive legal certainty until data set 18, 19 is added to the blockchain 20, or they wait until data set 18, 19 is added before they start the collaboration 23. In the specific embodiment according to FIG. 1, both systems 11, 12 wait until they have received a confirmation from transaction database 13 as to whether the block was successfully added.

As soon as data sets 18, 19 have been stored in transaction database 13 and the new blocks 21 were received by both systems 11, 12, each system 11, 12 may check 22, 23 whether the respective other party 12 or 11 has created a matching data set 19 or 18. If no data set was added, the ID of the opposite party is incorrect; if a data set was in fact added, but its ID does not match, an error or attack is likely, and the collaboration is abandoned. In FIG. 1, data sets 18, 19 of both systems 11, 12 match, and they start the collaboration 23.

Now the case shall be considered where one system 11, 12 fails and violates its guarantee or the safety contract, as is shown in FIG. 1 in the case of the second, right system 12 as shown in the illustration. If possible, first system 11 monitors the data received from second system 12 and checks whether it meets the arranged guarantees. When the corresponding monitoring component establishes a violation 25 of the safety contract, it terminates the collaboration 26 and attempts to transfer system 11 into a safe state. This may not be possible in the individual case since complex guarantees cannot be monitored in the first place. In any case, both manufacturers have access to the safety contract which both systems 11, 12 concluded, and neither of the two is thus able to deny the concluding of the contract. In the event of a guarantee violation or an accident, each manufacturer thus has to verify that its system 11, 12 satisfied this safety contract. It should be noted that this procedure essentially corresponds to the customary process after an accident between conventional vehicles, where the road traffic rules correspond to the safety contract.

A first variant of method 10 addresses the problem that, if the participating systems 11, 12 fail, their manufacturers are able to verify that a safety contract existed, but cannot prove that the respective other system 12, 11 violated it. One option for facilitating this verification is that the safety contract contains a clause according to which both systems 11, 12 have to periodically transmit a representation of their system state, including their surroundings model (camera image, position in the map etc.), as defined in the safety contract, to distributed transaction database 13.

A second variant is similar to the first, however each system 11, 12 creates a cryptographic hash of its entire surroundings model, and stores the model and the hash in a local database.

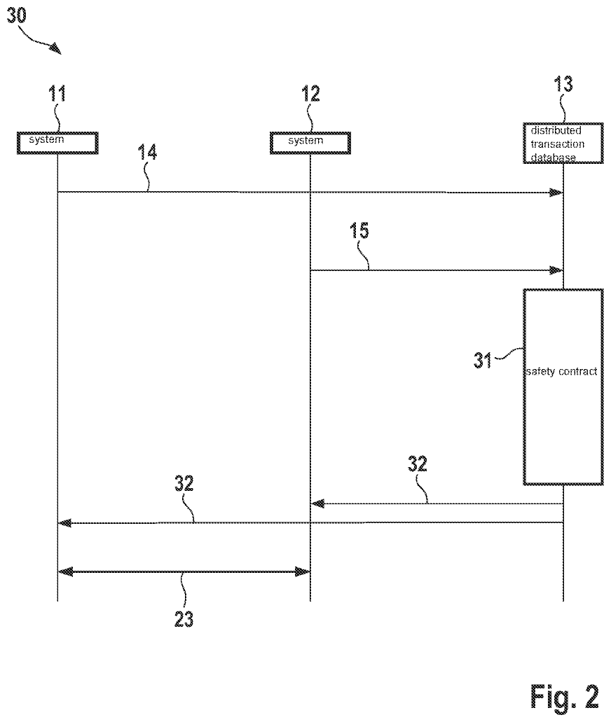

A third variant 30 in FIG. 2 utilizes the option of several distributed transaction databases calculating executable instructions contained in a data set, in a manner which is distributed among multiple terminals. An example of such a transaction database is the Ethereum cryptocurrency, which meets corresponding functions for digital contracts. It is thus also possible that both systems 11, 12 transmit their assumptions and guarantees to a distributed transaction database 13 including calculation capability, as shown in FIG. 2. Distributed transaction database 13 assesses the assumptions and guarantees and, if successful, stores the safety contract 31. Systems 11, 12 begin the collaboration 23 as soon as each has received the block including its safety contract 32.

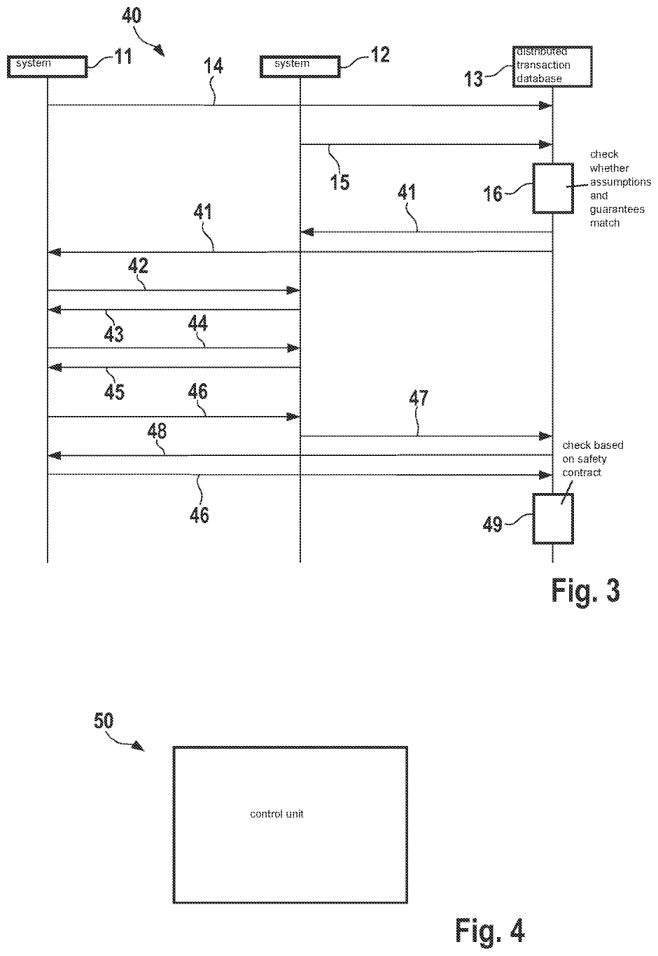

A fourth variant 40 illustrated in FIG. 3 expands the third variant as follows: Blockchains such as Lightning and Raiden have introduced a concept referred to as transaction or state channel. A state channel is a direct communication channel between systems 11, 12, and a digital contract in the blockchain which is concluded by these systems 11, 12. Systems 11, 12 directly exchange pieces of information via this channel. Receiving system 11, 12 acknowledges the respective received information 42, 44, 46 with a cryptographically signed message 43, 45 when it consents to the received message. If both systems 11, 12 want to end the collaboration or one of systems 11, 12 establishes that the received information, here 46, violates the safety contract, e.g., the braking force of an accordingly equipped vehicle exceeds the maximum value defined in the safety contract, it may execute 47 a billing function in the digital contract in the blockchain. Both systems 11, 12 then, to a certain extent, have to “convince” the digital contract of the latest mutually agreed state by transmitting their consent messages.

The focus of the specific embodiments explained thus far is the legal certainty for the collaborating systems 11, 12 due to the tamper-proof design of the blockchain. However, since computing power is expended for maintaining and updating blocks, a reward for the proof of work (PoW) provided in this regard is also desirable. A fifth variant of method 10 thus provides that the participating systems are equipped with mechanisms, for example to carry out transactions with the aid of digital wallets in order to store units of a virtual currency as a unit of value for the collaboration.

According to a sixth variant, the incorporation of the trustworthiness of a system, assessed by earlier collaboration partners, may limit the selection of the partner for a later collaboration. With respect to such an application, a virtual crypto wallet may also store the aforementioned trustworthiness. This would make it possible, for example, that a product is certified for the use in certain interaction scenarios (and it is thus assigned a trustworthiness), by which the collaboration is limited to products which should, in principle, be compatible. The trust extended to the other system may increase over the course of time, depending on the quantity and quality of its collaboration. The resulting assessment thus not only benefits the terminals involved in the blockchain, but also certification authorities and other trustees.

Finally, according to a seventh variant, the safety contracts may be transmitted by the systems to a central server or a database which the manufacturers of the systems trust, instead of to the blockchain.

This method may be implemented in software or hardware or in a mixed form made up of software and hardware, for example in a control unit 50, as the schematic representation of FIG. 4 illustrates.

1-10. (canceled)

11. A method for agreeing to a collaboration between a first system and a second system, the method comprising the following steps:
transmitting, by the first system, assumptions of the first system with respect to the second system, and guarantees of the first system;
transmitting, by the second system, assumptions of the second system with respect to the first system, and guarantees of the second system to the first system;
when reciprocal assumptions and guarantees of the first system and the second system correspond to one another, concluding a digital safety contract between the first system and the second system; and
documenting the safety contract in a transaction database.

12. The method as recited in claim 11, further comprising the following steps:
receiving, by the second system, the assumptions of the first system with respect to the second system, and the guarantees of the first system to the second system;
receiving, by the first system, the assumptions of the second system with respect to the first system, and the guarantees of the second system to the first system;
checking, by the first system, whether the guarantees of the second system correspond to the assumptions of the first system, and, when necessary, the first system transmitting a first entry including the safety contract and an identifier of the second system to the transaction database;
checking, by the second system, whether the guarantees of the first system correspond to the assumptions of the second system, and, when necessary, transmitting a second entry including the safety contract and an identifier of the first system to the transaction database;
adding, by the transaction database, the first and second entries to a blockchain;
transmitting, by the transaction database, the added first and second entries of the blockchain to the first system and the second system;
checking, by the first system, the second entry;
checking, by the second system, the first entry;
when the first and second entries match, starting, by the first system and the second system, the collaboration; and
when one system of the first and second systems establishes a violation of the safety contract by the other of the first and second system, terminating, by the one system, the collaboration.

13. The method as recited in claim 12, wherein:
after starting the collaboration, each of the first system and the second system repeatedly transmits a surroundings model to the transaction database; and
the transaction database adds the surroundings models to the blockchain.

14. The method as recited in claim 12, wherein:
after starting the collaboration, each of the first system and the second system repeatedly transmits a hash of a surroundings model to the transaction database; and
the transaction database adds the hashes to the blockchain.

15. The method as recited in claim 11, further comprising the following steps:
receiving, by the transaction database, the assumptions of the first system with respect to the second system, the guarantees of the first system to the second system, the assumptions of the second system with respect to the first system, and the guarantees of the second system to the first system;
checking, by the transaction database, whether the guarantees of the second system correspond to the assumptions of the first system, and the guarantees of the first system correspond to the assumptions of the second system, and, when necessary, the transaction database drawing up the safety contract, and adding a block including the safety contract to the blockchain;
transmitting, by the transaction database, the block including the safety contract to the first system and the second system; and
when the first system and the second system receive the block, starting, by the first system and the second system, the collaboration.

16. The method as recited in claim 15, wherein:
the first system and the second system establish a reciprocal transaction channel;
after the block including the safety contract has been received, the first and second systems exchange pieces of information and signed messages via the transaction channel;
when one system of the first and second systems receives a piece of information violating the safety contract, the one system asks the transaction database for arbitration;
the transaction database notifies the other system of the arbitration, requests from the other system the piece of information violating the safety contract, and checks the piece of information violating the safety contract based on the safety contract.

17. The method as recited in claim 12, wherein:
the blockchain is distributed among numerous terminals;
the first and second systems manage a digital wallet; and
the terminals are remunerated from the digital wallet for adding the blocks.

18. A non-transitory machine-readable memory medium on which is stored a computer program for agreeing to a collaboration between a first system and a second system, the computer program, when executed by a computer, causing the computer to perform the following steps:
transmitting, by the first system, assumptions of the first system with respect to the second system, and guarantees of the first system;
transmitting, by the second system, assumptions of the second system with respect to the first system, and guarantees of the second system to the first system;
when reciprocal assumptions and guarantees of the first system and the second system correspond to one another, concluding a digital safety contract between the first system and the second system; and
documenting the safety contract in a transaction database.

19. A device configured to agree to a collaboration between a first system and a second system, the device configured to:
transmit, by the first system, assumptions of the first system with respect to the second system, and guarantees of the first system;
transmit, by the second system, assumptions of the second system with respect to the first system, and guarantees of the second system to the first system;
when reciprocal assumptions and guarantees of the first system and the second system correspond to one another, conclude a digital safety contract between the first system and the second system; and
document the safety contract in a transaction database.
